(19) United States
(12) Patent Application Publication
(10) Pub. No.: US 2019/0115614 A1
(43) Pub. Date: Apr. 18, 2019

(54) BATTERY MODULE

(71) Applicant: HONDA MOTOR CO., LTD., Tokyo (JP)

(72) Inventor: Atsushi SAKURAI, Saitama (JP)

(73) Assignee: HONDA MOTOR CO., LTD., Tokyo (JP)

(21) Appl. No.: 16/127,493

(22) Filed: Sep. 11, 2018

(30) Foreign Application Priority Data
Oct. 16, 2017 (JP) 2017-200595

(51) Int. Cl. H01M 10/04; H01M 2/10

(52) U.S. Cl. CPC H01M 10/0486; H01M 2/1016

(57) ABSTRACT

A battery module includes: a cell stack which is constituted by stacking a plurality of cells in a first direction and includes a first surface, a second surface, a third surface, a fourth surface, a fifth surface, and a sixth surface; a pair of end plates which is disposed on the first surface and the second surface of the cell stack; and a frame which connects the pair of end plates. The frame includes a pair of connection frames disposed on the third surface and the fourth surface of the cell stack, and a base plate disposed on the sixth surface of the cell stack. The pair of end plates each has a protruding portion in a surface facing the base plate, and the base plate has a groove portion which accommodates the protruding portion and extends in the first direction.

### CROSS-REFERENCE TO RELATED APPLICATION (S)

This application claims priority from Japanese Patent Application No. 2017-200595 filed on Oct. 16, 2017, the entire contents of which are incorporated herein by reference.

### FIELD

The present invention relates to a battery module mounted on an electric vehicle or the like.

### BACKGROUND

In the related art, a battery module is mounted on an electric vehicle or the like. For example, JP-A-2012-256466 discloses a battery module which includes a cell stack, a pair of end plates disposed at both end portions of the cell stack in a stacking direction, and a pair of ladder frames connecting the pair of end plates.

In a battery module of this type, a load (hereinafter, referred to as a cell thickness restraint reaction force as appropriate) in a cell stacking direction of the battery module is generated by cell expansion due to temperature change and aging deterioration. In recent years, due to an increase in cell capacity and an increase in energy density, it is in the direction of packing more active material in the cell, and thus the cell thickness restraint reaction force increases.

However, in a battery module of JP-A-2012-256466, a pair of end plates is rigidly connected by a ladder frame, and thus it is difficult to alleviate the cell thickness restraint reaction force.

### SUMMARY

The invention provides a technique capable of alleviating the cell thickness restraint reaction force by allowing displacement of the end plate in a cell stacking direction in the battery module.

An aspect of the invention defines a battery module including:

a cell stack which is constituted by stacking a plurality of cells in a first direction and includes a first surface which is a surface on one end side in the first direction, a second surface which is a surface on the other end side in the first direction, a third surface which is a surface on one end side in a second direction perpendicular to the first direction, a fourth surface which is a surface on the other end side in the second direction, a fifth surface which is a surface on one end side in a third direction perpendicular to the first direction and the second direction, and a sixth surface which is a surface on the other end side in the third direction;

a pair of end plates which is disposed on the first surface and the second surface of the cell stack; and

a frame which connects the pair of end plates, in which

the frame includes a pair of connection frames disposed on the third surface and the fourth surface of the cell stack, and a base plate disposed on the sixth surface of the cell stack,

the pair of end plates each has a protruding portion in a surface facing the base plate, and

the base plate has a groove portion which accommodates the protruding portion and extends in the first direction.

According to the aspect described above, a movement of the protruding portion of the end plate in the first direction is allowed by the groove portion of the base plate, that is, displacement of the end plate in a cell stacking direction is allowed, and thus it is possible to alleviate a cell thickness restraint reaction force of a cell stack.

### BRIEF DESCRIPTION OF DRAWINGS

FIG. 1 is a perspective view of a battery module according to a first embodiment of the invention when viewed obliquely from above.

FIG. 2 is a perspective view of the battery module of FIG. 1 when viewed obliquely from below.

FIG. 3 is an exploded perspective view of the battery module of FIG. 1.

FIG. 4 is a front view of the battery module of FIG. 1.

FIG. 5 is a perspective view of an end plate of the battery module of FIG. 1 when viewed obliquely from below.

FIG. 6 is a perspective view of a battery module according to a second embodiment of the invention when viewed obliquely from above.

FIG. 7 is a perspective view of the battery module of FIG. 6 when viewed obliquely from below.

FIG. 8 is an exploded perspective view of the battery module of FIG. 6.

FIG. 9 is a perspective view of a lower plate of the battery module of FIG. 6 when viewed obliquely from above.

FIG. 10 is a cross-sectional view taken along a line A-A in FIG. 7.

FIG. 11 is a cross-sectional view taken along a line B-B in FIG. 7.

### DETAILED DESCRIPTION

Hereinafter, embodiments of a battery module of the invention will be described with reference to the accompanying drawings. The drawings are to be seen in reference sign directions.

### First Embodiment

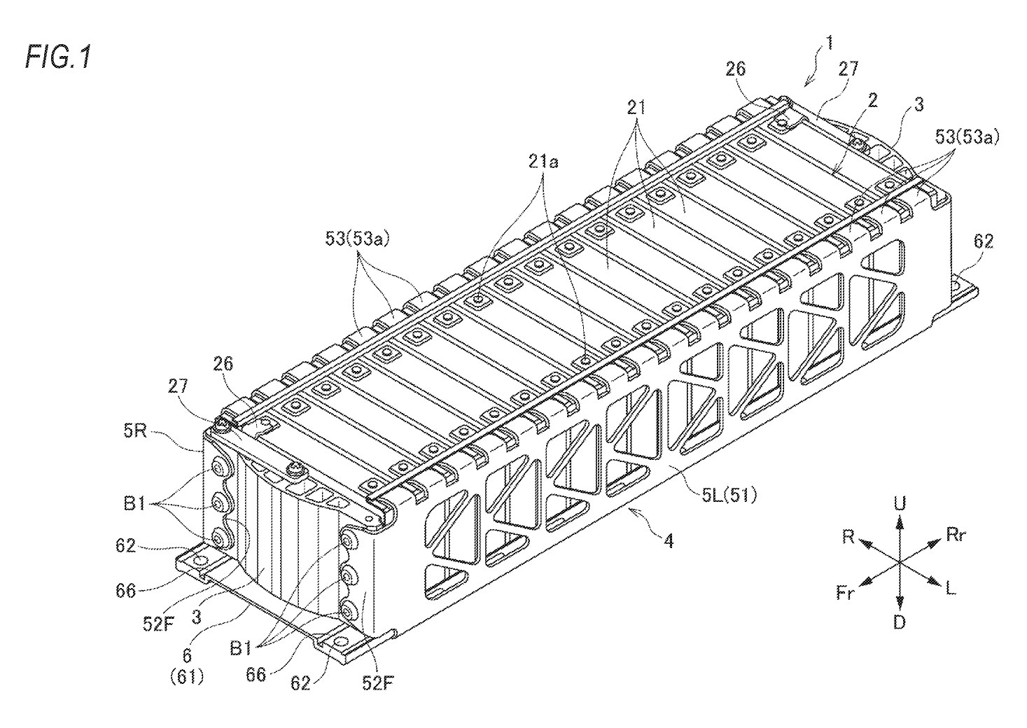

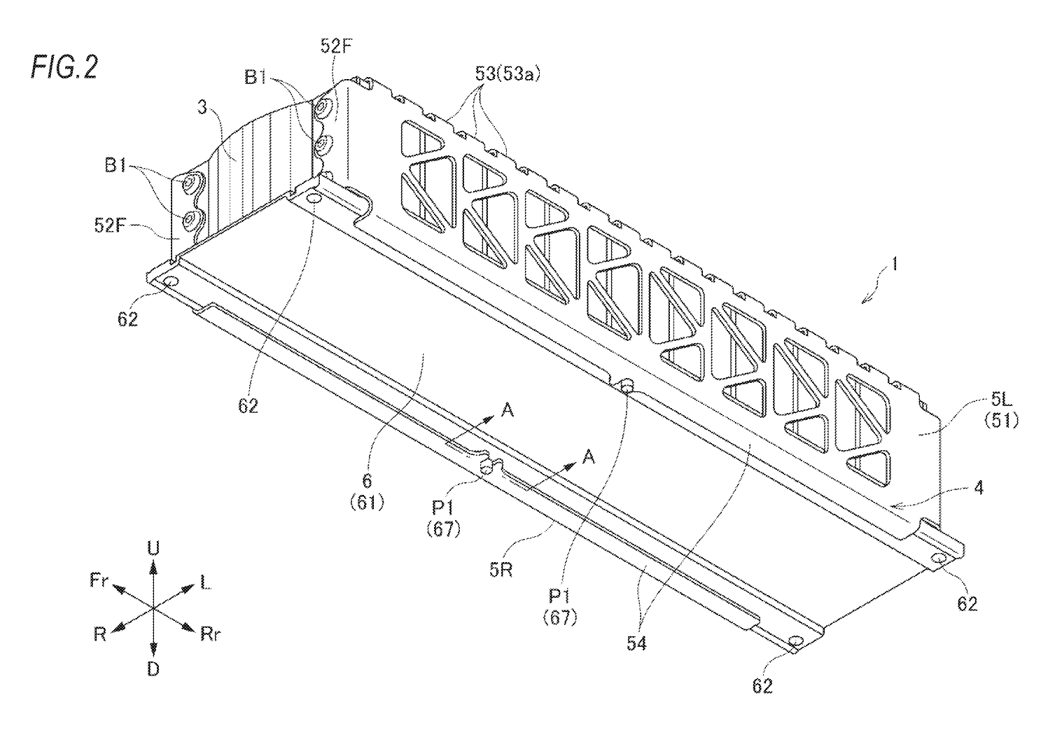

First, a battery module according to a first embodiment of the invention will be described with reference to FIGS. 1 to 5.

### Battery Module

As illustrated in FIG. 1, a battery module 1 according to the embodiment includes a cell stack 2 which is constituted by stacking a plurality of cells 21 in a front-rear direction and includes a front surface, a rear surface, a left surface, a right surface, an upper surface, and a lower surface, a pair of end plates 3 disposed on a front surface and a rear surface of the cell stack 2, and a frame 4 connecting the pair of end plates 3. The frame 4 includes a right side frame 5R disposed on a right surface of the cell stack 2, a left side frame 5L disposed on a left surface of the cell stack 2, and a lower plate 6 disposed on a lower surface of the cell stack 2.

In the specification and the like, in order to make the explanation simple and clear, a stacking direction of the cells 21 is defined as a front-rear direction and directions perpendicular to the stacking direction of the cells 21 are defined as a left-right direction and an up-down direction, and further it is irrelevant to a front-rear direction and the like of a product on which the battery module 1 is mounted. That is, when the battery module 1 is mounted on a vehicle, the stacking direction of the cells 21 may be coincident with a front-rear direction of the vehicle and it may be an up-down direction or a left-right direction of the vehicle, and further ay be a direction inclined from those directions. In the drawing, the front of the battery module 1 is denoted by Fr, the rear is denoted by Rr, the left side is denoted by L, the right side is denoted by R, the upper side is denoted by U, and the lower side is denoted by D.

### (Cell Stack)

As illustrated in FIGS. 1 to 3, the cell stack 2 is formed by alternately stacking the plurality of cells 21 and a plurality of first insulating members 22 in the front-rear direction. The pair of end plates 3 is respectively disposed on the front surface and the rear surface of the cell stack 2 in an insulated state via second insulating members 23. The lower plate 6 is disposed on the lower surface of the cell stack 2 in an insulated state via a third insulating member 24. Further, the right side frame 5R and the left side frame 5L are disposed on the right surface and the left surface of the cell stack 2 in an insulated state with a slight gap therebetween. On the upper surface of the cell stack 2, a pair of fourth insulating members 25 is disposed at a left end portion and a right end portion. The third insulating member 24 is disposed in a position where the third insulating member does not overlap with the end plate 3 in the front-rear direction.

It is known that the cell 21 expands due to temperature change and aging deterioration. The cell 21 has a rectangular parallelepiped shape in which the length in the up-down direction is longer than that of the front-rear direction and the length in the left-right direction is longer than that of the up-down direction. Therefore, the area of the front surface or the rear surface of the cell 21 is much larger than the area of the left surface, the right surface, the upper surface, or the lower surface and a central portion in the left-right direction and a central portion in the up-down direction are easily expanded on the front surface and the rear surface of the cell 21.

On the upper surface of the cell stack 2, a plurality of bus bars electrically connected to terminals 21a of the cell 21 are arranged. The bus bars include a bus bar (not illustrated) for connecting the terminals 21a of the cell 21 to each other and a bus bar 26 for connecting the terminal 21a of the cell 21 to an external connection terminal 27.

### (End Plate)

As illustrated in FIGS. 1 to 5, the pair of end plates 3 respectively abut on the front surface and the rear surface of the cell stack 2 via the second insulating members 23 to receive a load (also referred to as a cell thickness restraint reaction force as described above) of the cell stack 2 in the cell stacking direction. The load of the cell stack 2 in the cell stacking direction is mainly caused by expansion of the cell 21 due to temperature change and aging deterioration. As described above, in the front surface and the rear surface of the cell 21, the central portion in the left-right direction and the central portion in the up-down direction are easily expanded, so that a large load is input to the central portion in the left-right direction and the central portion in the up-down direction of the end plate 3.

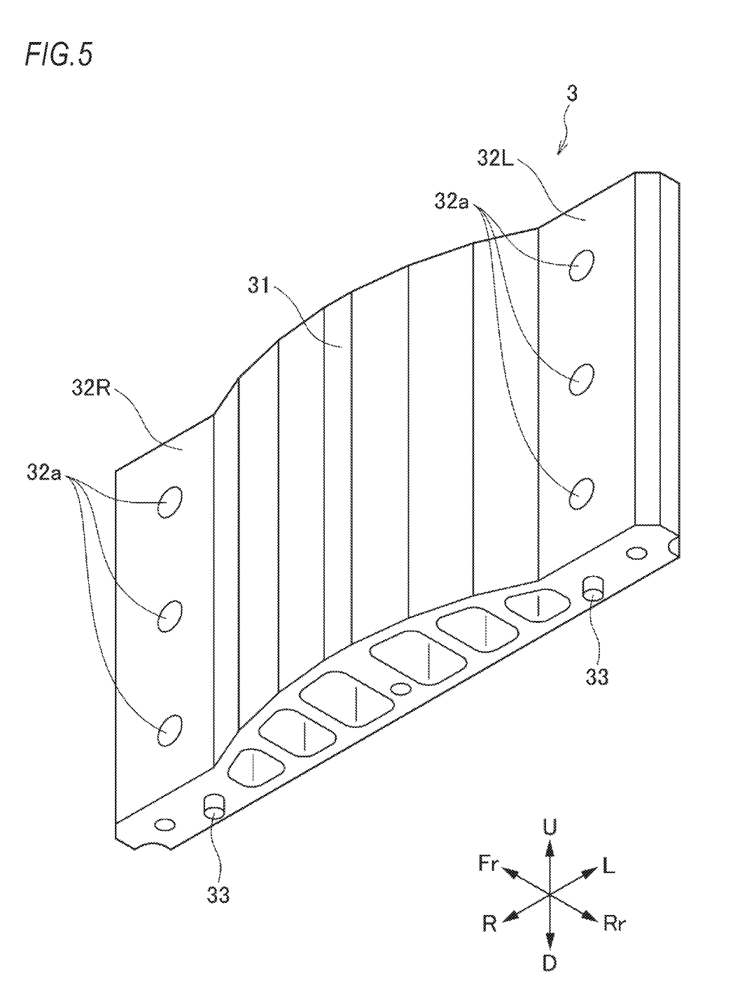

As illustrated in FIG. 5, the end plate 3 is formed using an aluminum extruded material and includes a central end plate portion 31 formed in a central region in a right-left direction and a left end plate portion 32L and a right end plate portion 32R formed so as to interpose the central end plate portion 31 in the right-left direction. As described above, the central end plate portion 31 receiving a large load in the cell stacking direction from the cell stack 2 has a width in a front-rear direction larger than a width of the left end plate portion 32L or the right end plate portion 32R in the front-rear direction. Therefore, in the end plate 3, an inner surface abut with the cell stack 2 is flat, whereas, on an outer surface not abut with the cell stack 2, the central end plate portion 31 has a shape bulging outward.

On outer surfaces of the left end plate portion 32L and the right end plate portion 32R, a plurality of fastening portions 32a fastened to the left side frame 5L or the right side frame 5R via bolts B1 are provided. Protruding portions 33 engaging with the lower plate 6 are provided on a lower surface of the left end plate portion 32L and a lower surface of the right end plate portion 32R which face (abut on) an upper surface of the lower plate 6. In the end plate 3 of the embodiment, two protruding portions 33 are provided on both left and right end sides of the lower surface. However, the number of the protruding portions 33 may be one or three or more and a position where the protruding portion 33 is provided may be a center side of the lower surface of the end plate 3 in the right-left direction.

Further, on the upper surface of the end plate 3, the external connection terminal 27 is provided for exchanging electric power between the battery module 1 and an external electric device. When the end plate 3 is positionally shifted in its width direction (left-right direction), stress is generated between the terminal 21a of the cell 21 and the bus bar 26, and this may cause connection failure. Therefore, it is desirable to prevent the movement of the end plate 3 in the width direction as much as possible.

### (Side Frame)

As illustrated in FIGS. 1 to 4, the left side frame 5L and the right side frame 5R are formed by pressing a metal plate material and include a side frame body 51 which extends along the left surface or the right surface of the cell stack 2, a front flange portion 52F which extends from a front end of the side frame body 51 along a front surface of the end plate 3 on a front side in a direction where the front flange portion 52F and the front surface of the end plate 3 approach each other, a rear flange portion 52R which extends from a rear end of the side frame body 51 along a rear surface of the end plate 3 on a rear side in a direction where the rear flange portion 52R and the rear surface of the end plate 3 approach each other, an upper flange portion 53 which extends from an upper end of the side frame body 51 along the upper surface of the cell stack 2 in a direction where the upper flange portion 53 and the upper surface of the cell stack 2 approach each other, and a lower flange portion 54 which extends from a lower end of the side frame body 51 along the lower surface of the cell stack 2 (lower plate 6) in a direction where the lower flange portion 54 and the lower surface of the cell stack 2 approach each other.

The front flange portion 52F and the rear flange portion 52R are provided with a plurality of fastening portions 52a fastened to the end plate 3 on the front side or the end plate 3 on the rear side via the bolts B1. The fastening portion 52a has a round hole through which the bolt BI is inserted. The bolt B1 inserted in the round hole is screwed into the fastening portion 32a of the end plate 3 on the front side or the end plate 3 on the rear side, in such a manner that the front flange portion 52F and the rear flange portion 52R are fastened to the end plate 3 on the front side or the end plate 3 on the rear side. As a result, the pair of end plates 3 is connected via the left side frame 5L and the right side frame 5R.

The left side frame 5L and the right side frame SR allow the relative displacement of the end plates 3 in the front-rear direction when the load of the cell stack 2 in the cell stacking direction increases. For example, deformation of the side frame body 51 in the front-rear direction, angular change between the side frame body 51 and the front flange portion 52F, angular change between the side frame body 51 and the rear flange portion 52R, and the like allow relative displacement of the end plates 3 in the front-rear direction.

The upper flange portion 53 and the lower flange portion 54 pinch the fourth insulating member 25, the cell stack 2, and the lower plate 6 from the up-down direction at the left end portion and the right end portion of the cell stack 2. As a result, it is possible to prevent the relative positional fluctuation of the cell stack 2, the fourth insulating member 25, the left side frame 5L, the right side frame 5R, and the lower plate 6 in the up-down direction and to arrange the plurality of cells 21 constituting the cell stack 2.

The upper flange portion 53 has elasticity, and thus the elastic deformation in the up-down direction is allowed. Therefore, when the right side frame 5R and the left side frame 5L are attached to the cell stack 2 and the lower plate 6 from the right-left direction, the upper flange portion 53 is elastically deformed to facilitate attachment and the cell stack 2 can be elastically pinched between the upper flange portion 53 and the lower flange portion 54 to improve the vibration resistance.

The upper flange portion 53 of the embodiment is constituted by a plurality of elastic pieces 53a aligned in the front-rear direction and a number and position of the elastic pieces 53a are determined in correspondence with a number and position of the cells 21 stacked in the front-rear direction. Thus, the upper flange portion 53 can hold the plurality of cells 21 individually elastically while having moderate elasticity.

In the right side frame 5R and the left side frame 5L of the embodiment, the upper flange portion 53 is press-formed integrally with the side frame body 51. However, the upper flange portion 53 may be subjected to press-forming separately from the side frame body 51, and then the upper flange portion 53 may be integrated with the side frame body 51 by welding or caulking.

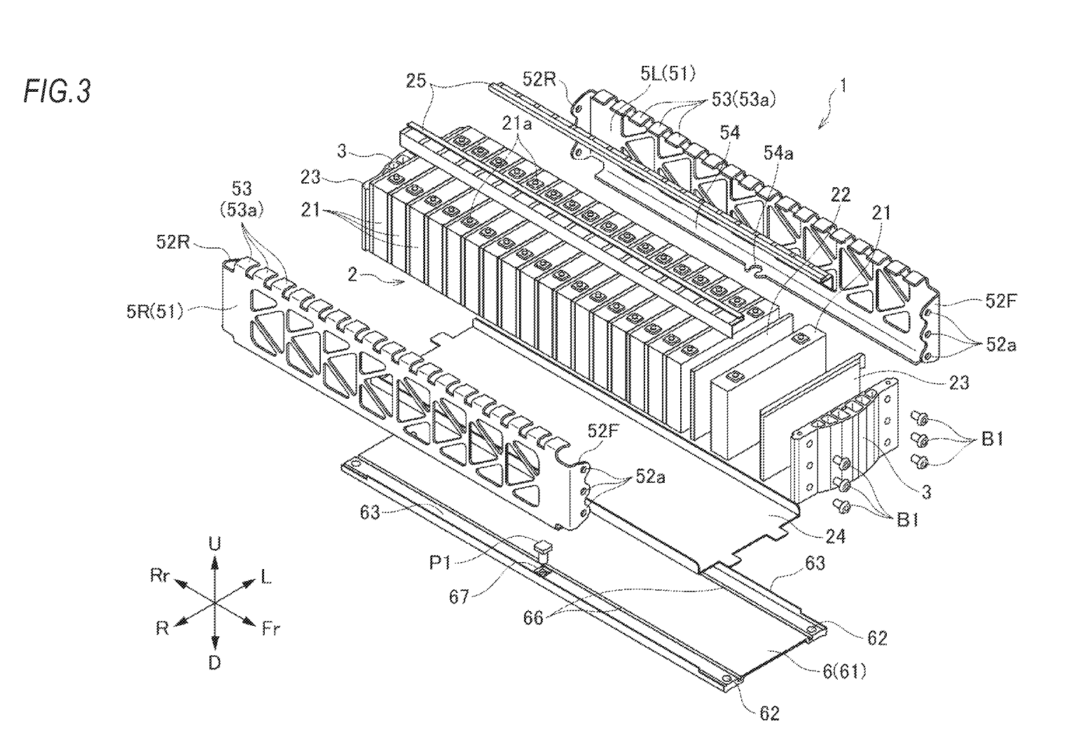

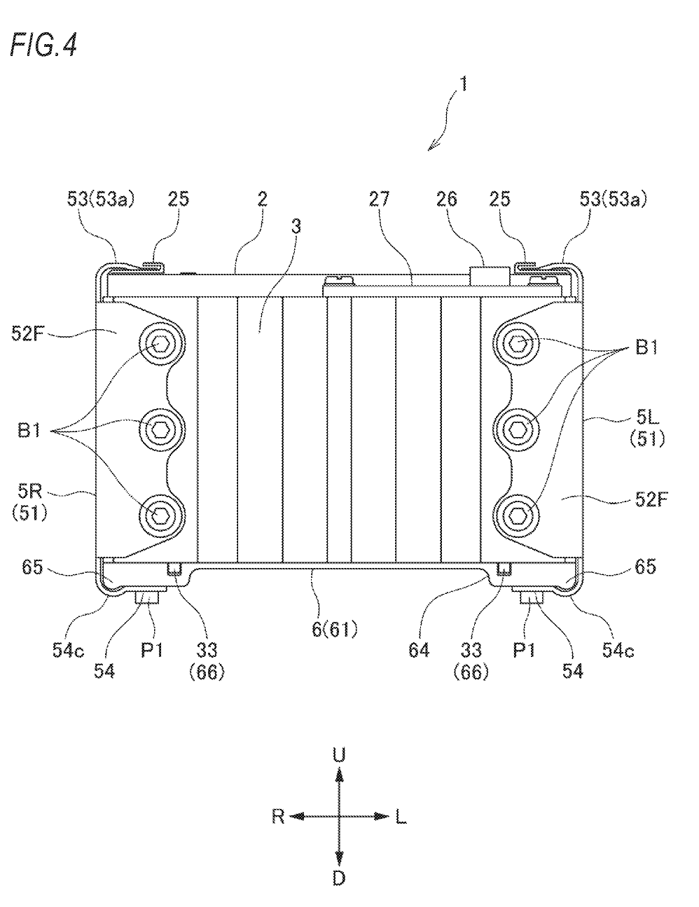

In the lower flange portion 54, a retained portion 54a (see FIG. 3) which is press-fitted and fixed to a pin P1 provided on the lower plate 6 and a plate engaging portion 54c (see FIG. 4) which is constituted by a concave portion extending in the front-rear direction at a base-end-side upper surface portion of the lower flange portion 54 and engaged with the lower plate 6 are provided. The retained portion 54a is provided at a center portion of the lower flange portion 54 in the front-rear direction.

The retained portion 54a provided in the lower flange portion 54 of the right side frame 5R is a cut opening in a left direction and the retained portion 54a provided in the lower flange portion 54 of the left side frame 5L is a cut opening in a right direction. Thus, the right side frame 5R and the left side frame 5L can be mounted from the left-right direction.

### (Lower Plate)

As illustrated in FIGS. 1 to 4, the lower plate 6 is formed by using an aluminum extruded material and includes a lower plate body 61 which extends along the lower surfaces of the cell stack 2 and the end plate 3, a plurality of fixing portions 62 which are fixed to a module supporting structure (not illustrated) supporting the battery module 1, guide portions 63 which protrude upward from both left and right end portions of the lower plate body 61 and extend along the front-rear direction, a temperature regulating device accommodation portion 64 which is recessed in a central portion of the lower surface of the lower plate body 61 in the left-right direction, frame engaging portions 65 which engage with the plate engaging portions 54c of the left side frame 5L and the right side frame 5R, groove portions 66 which accommodate the protruding portion 33s of the end plate 3, and retaining portions 67 which retain the retained portions 54a of the lower flange portions 54 via the pins P1.

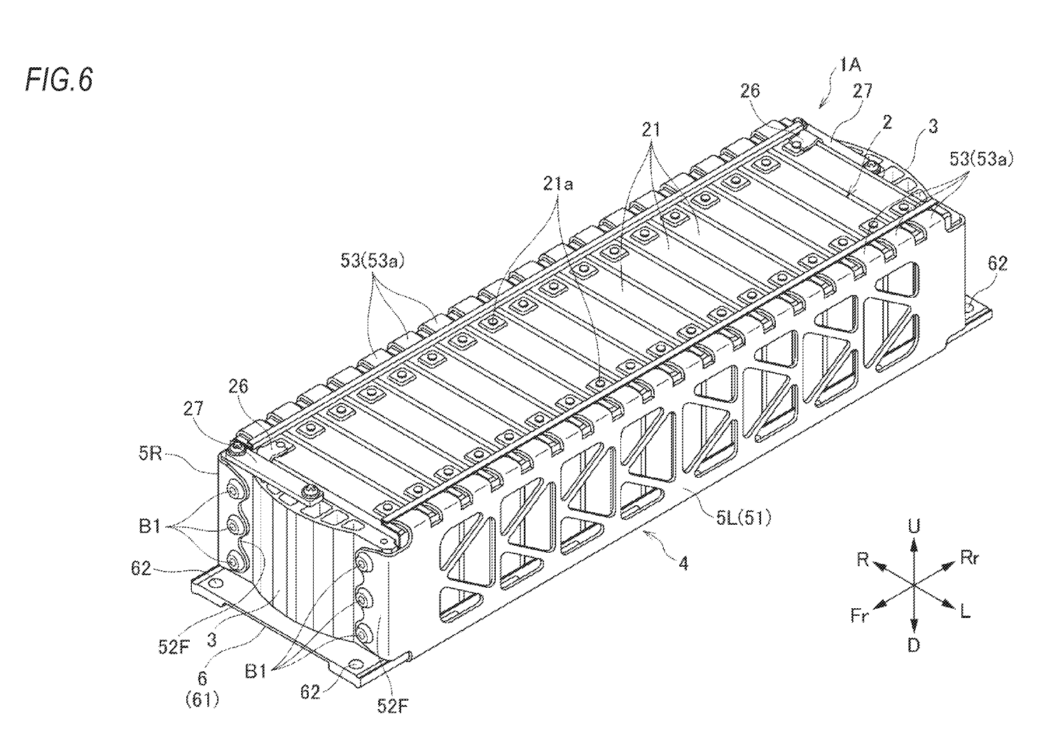

As illustrated in FIG. 6, the fixing portions 62 are provided at the four corners of the lower plate body 61 which is rectangular in plan view and is fixed to the module supporting structure via fixing tools such as bolts. According to the fixing structure of the battery module 1, the lower plate 6 is fixed to the module supporting structure. Therefore, even when a cell thickness restraint reaction force increases by expansion of the cell 21 due to temperature change and aging deterioration and accordingly the end plate 3 moves in the front-rear direction, stress transmission to module supporting structure can be avoided.

In the embodiment, when the fixing portions 62 of the lower plate 6 are disposed on the front side of the front end plate 3 and the rear side of the rear end plate 3, the fixing portions 62 of the lower plate 6 are disposed at positions overlapping the left end plate portion 32L and the right end plate portion 32R having a smaller width in the front-rear direction than that of the central end plate portion 31 in the left-right direction. Therefore, a length of the lower plate 6 for providing the fixing portions 62 can be reduced and a length of the battery module 1 in the front-rear direction can be reduced.

The guide portions 63 protrude upward from both left and right end portions of the lower plate body 61 as if following along the left surface and the right surface of the cell stack 2 and extend in the front-rear direction. Therefore, the displacement of the cell stack 2 in the left-right direction is regulated by the guide portion 63, so that the vibration resistance can be improved.

The lower plate body 61 is formed by using an aluminum extruded material and disposed close to the lower surface of the cell stack 2 so as to function also as a heat radiation member for transferring heat of the cell stack 2 to radiate the heat. In addition, in the lower plate body 61 of the embodiment, the temperature regulating device accommodation portion 64 is recessed on the lower surface, and thus a temperature regulating device (not illustrated) can be disposed below the lower plate body 61 to control the temperature of the cell stack 2 while the vertical size of the battery module 1 is suppressed.

The frame engaging portions 65 are constituted of convex portions extending in the front-rear direction at both left and right end portions of the lower surface of the lower plate body 61 and engage with the plate engaging portions 54c formed in the lower flange portions 54 of the left side frame 5L and the right side frame 5R. Therefore, the movement of the left side frame 5L and the right side frame 5R in the left-right direction with respect to the lower plate 6 is restricted.

The groove portions 66 are constituted of concave grooves extending in the front-rear direction at both left and right end portions of the upper surface of the lower plate body 61 and accommodate the protruding portions 33 provided on the lower surface of the end plate 3. Thus the displacement of the end plate 3 in the left-right direction with respect to the lower plate 6 is regulated while the displacement of the end plate 3 in the front-rear direction with respect to the lower plate 6 is allowed. Therefore, the displacement of the end plate 3 in the cell stacking direction is allowed to alleviate the cell thickness restraint reaction force and the movement of the end plate 3 in the width direction is prevented, and therefore connection failure between the terminal 21a and the bus bar 26 and the like can be prevented.

The retaining portions 67 are provided at the center portions in the front-rear direction at both left and right end portions of the lower plate 6. In the retaining portions 67, the retained portions 54a of the left side frame 5L and the right side frame SR are press-fitted so as to be immovable in the front-rear direction. Therefore, it is possible to average the displacement amount of the pair of end plates 3 while the displacement of the both end sides of the left side frame 5L and the right side frame SR in the front-rear direction and the displacement of the end plate 3 in the cell stacking direction are allowed.

### Second Embodiment

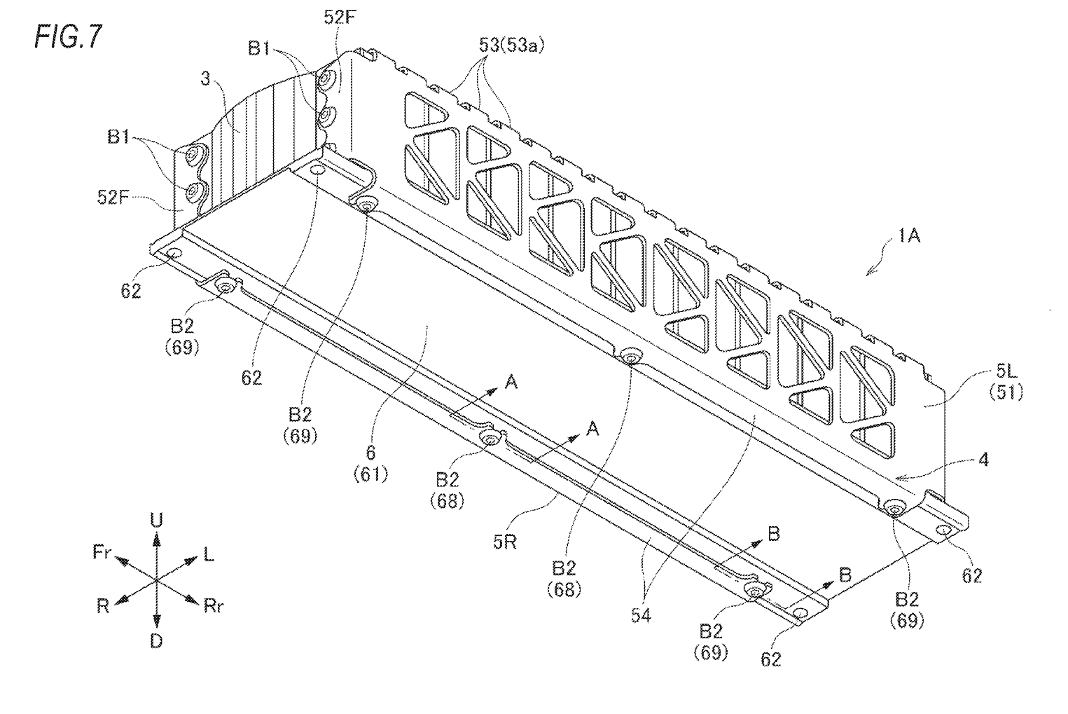

Next, a battery module 1A according to a second embodiment of the invention will be described with reference to FIGS. 6 to 11. In the following description, the same constituent elements as those of the battery module 1 of the first embodiment are denoted by the same reference numerals and characters and the description thereof will be omitted or simplified. In the battery module 1 of the first embodiment, in order to alleviate the cell thickness restraint reaction force, the displacement of the end plate 3 in the cell stacking direction is allowed by the lower plate 6 and the end plate 3. However, in the battery module 1A of the second embodiment, the displacement of the end plate 3 in the cell stacking direction is allowed by the left side frame 5L and the right side frame 5R which connect the pair of end plates 3 and the lower plate 6. Hereinafter, differences between the battery module 1 of the first embodiment and the battery module 1A of the second embodiment will be described in detail.

### Battery Module

As illustrated in FIG. 6, the battery module 1A according to the embodiment includes the cell stack 2, the pair of end plates 3, and the frame 4 connecting the pair of end plates 3. The frame 4 includes the right side frame 5R disposed on the right surface of the cell stack 2, the left side frame 5L disposed on the left surface of the cell stack 2, and the lower plate 6 disposed on the lower surface of the cell stack 2.

### Side Frame

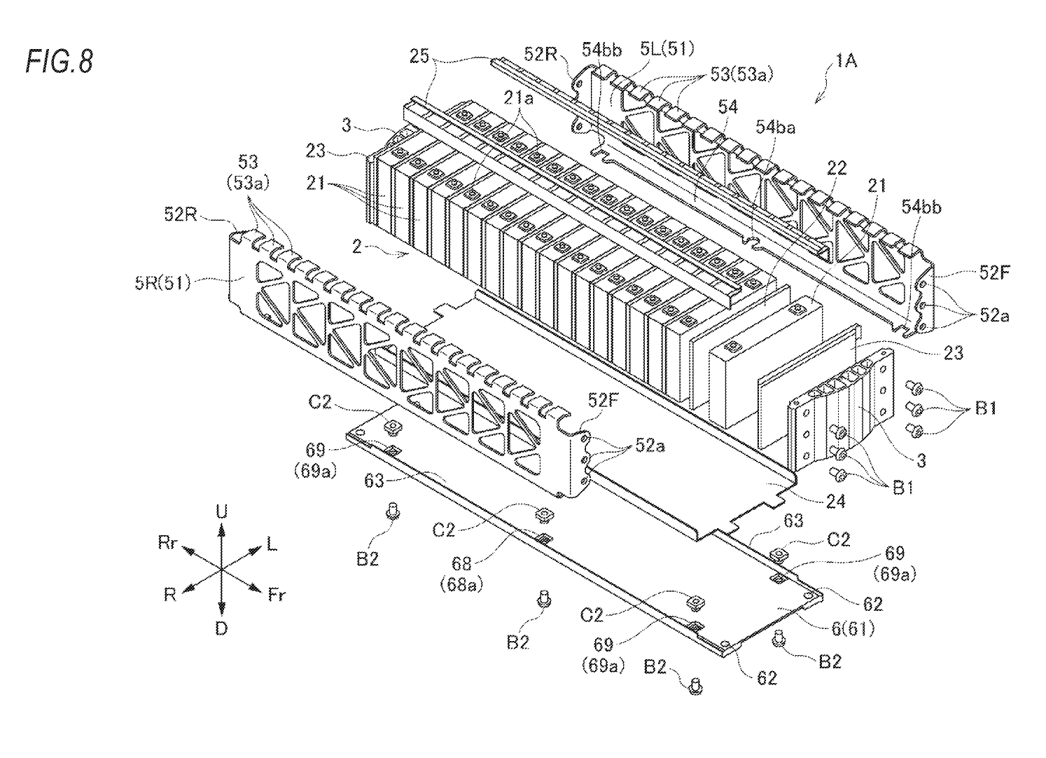

In the lower flange portions 54 of the right side frame 5R and the left side frame 5L a plurality of retained portions 54ba and 54bb (see FIG. 8) which are retained to the lower plate 6 via the bolts B2 and plate engaging portions 54c (not illustrated) which are constituted of concave portions extending in the front-rear direction on base side upper surface portions of the lower flange portions 54 and engage with the lower plate 6 are provided. The plurality of retained portions 54ba and 54bb includes a first retained portion 54ba provided at the center portion of the lower flange portion 54 in the front-rear direction and second retained portions 54bb provided in both end sides of the lower flange portion 54 in the front-rear direction.

The retained portions 54ba and 54bb provided in the lower flange portion 54 of the right side frame 5R are cut openings in the left direction and the retained portions 54ba and 54bb provided in the lower flange portion 54 of the left side frame 5L are cut openings in the right direction. Therefore, it is possible to attach the right side frame 5R and the left side frame 5L from the left-right direction in a state where the bolts B2 are temporarily fixed to the lower plate 6.

### (Lower Plate)

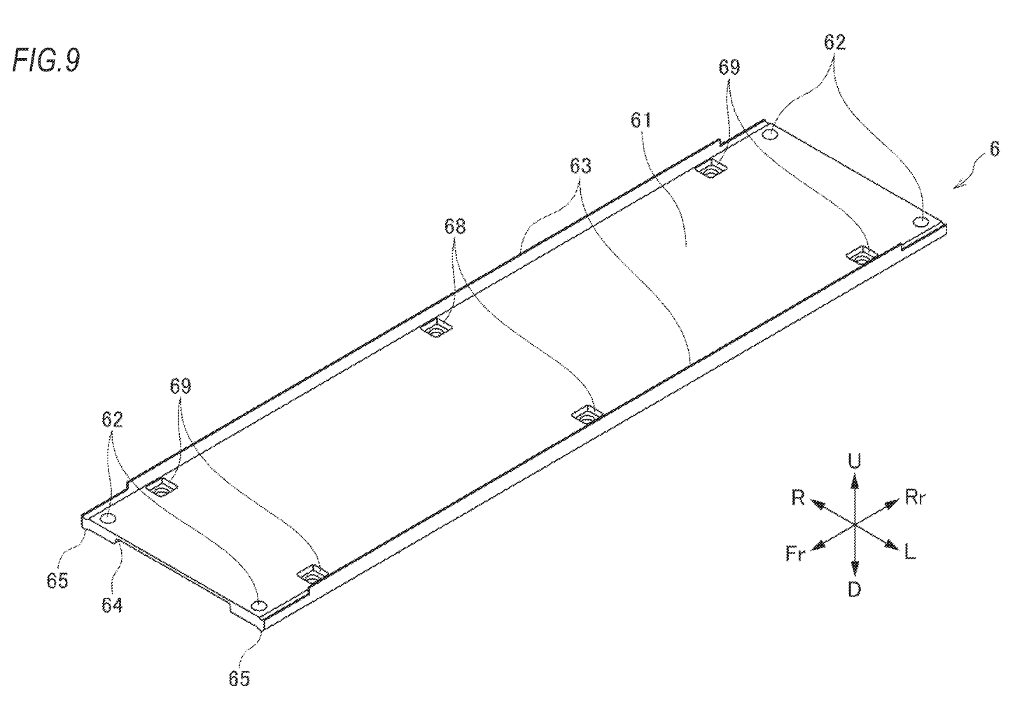

As illustrated in FIGS. 8 and 9, the lower plate 6 is formed by using an aluminum extruded material and includes the lower plate body 61 which extends along the lower surfaces of the cell stack 2 and the end plate 3, the plurality of fixing portions 62 which are fixed to the module supporting structure (not illustrated) supporting the battery module 1A, the guide portions 63 which protrude upward from both left and right end portions of the lower plate body 61 and extend along the front-rear direction, the temperature regulating device accommodation portion 64 which is recessed in the central portion of the lower surface of the lower plate body 61 in the left-right direction, the frame engaging portions 65 which engage with the plate engaging portions 54c of the left side frame 5L and the right side frame 5R, and a plurality of retaining portions 68 and 69 which retain the retained portions 54ba and 54bb of the lower flange portion 54 via the bolts B2.

The plurality of retaining portions 68 and 69 include first retaining portions 68 provided at the center portions in the front-rear direction in both left and right end portions of the lower plate 6 and second retaining portions 69 provided on both end sides in the front-rear direction in both left and right end portions of the lower plate 6. The first retained portions 54baof the left side frame 51, and the right side frame 5R are retained to the first retaining portions 68 so as to be immovable in the front-rear direction and the second retained portions 54bb of the left side frame 5L and the right side frame 5R are retained to the second retaining portions 69 so as to be movable in the front-rear direction. Therefore, it is possible to average the displacement amount of the pair of end plates 3 while the displacement of the both end sides of the left side frame 5L and the right side frame 5R in the front-rear direction and the displacement of the end plate 3 in the cell stacking direction are allowed.

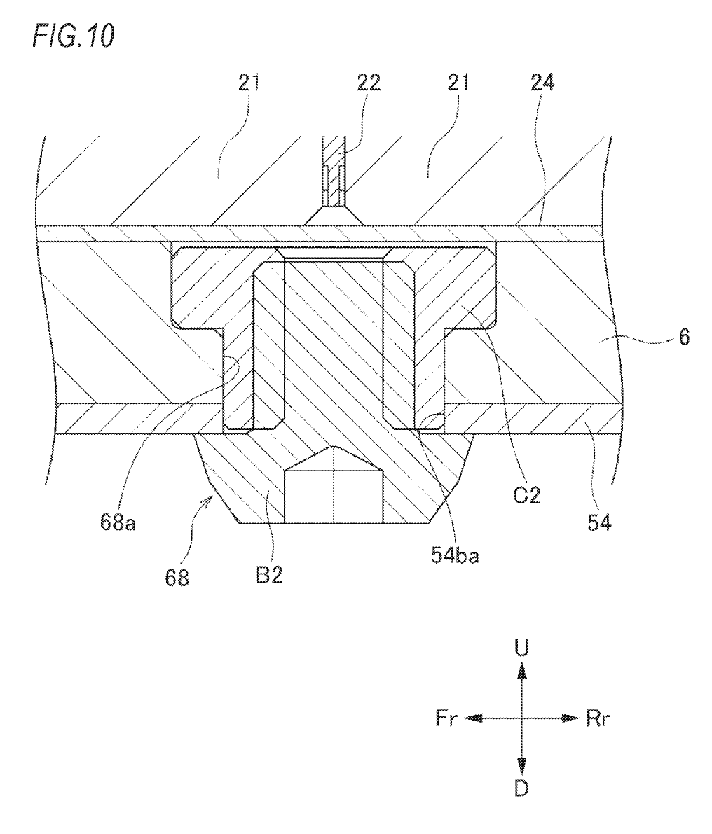

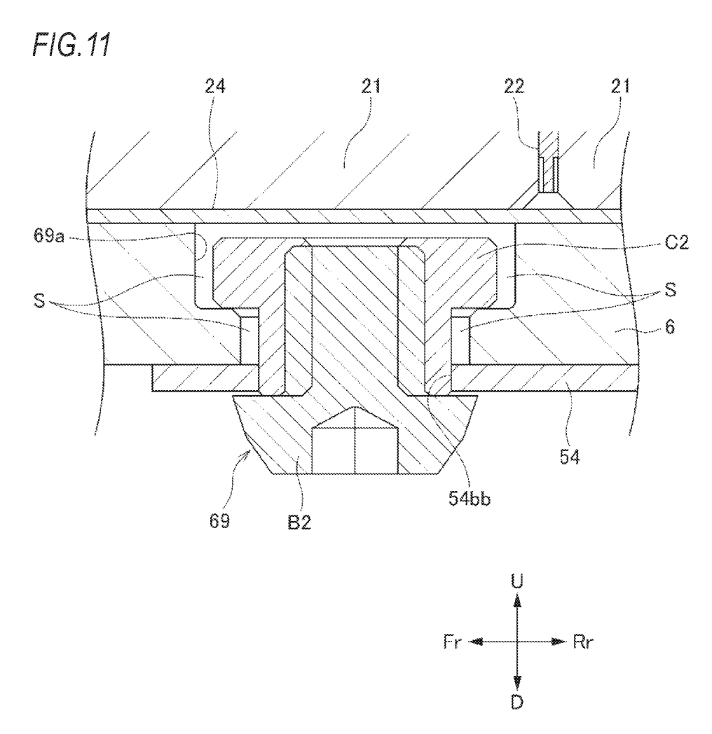

As illustrated in FIGS. 10 and 11, the first retaining portions 68 and the second retaining portions 69 of the embodiment include through holes 68a and 69a which pass through the lower plate body 61 in the up-down direction and of which the upper sides are noncircular holes and the lower sides are circular holes having a diameter smaller than that of the noncircular hole, collars C2 which are inserted in the through holes 68a and 69a in an unrotatable manner from above, and the bolts B2 which are screwed into the collars C2 from below. The inner dimension of the through hole 68a of the first retaining portions 68 is substantially the same as the outer dimension of the collar C2 and regulates the movement of the collar C2 in the front-rear direction. On the other hand, the through hole 69a of the second retaining portions 69 has an inner dimension larger than the outer dimension of the collar C2 in the front-rear direction and a gap S allowing the movement in the front-rear direction is formed between the inner periphery of the through hole 69a and the outer periphery of the collar C2. Therefore, the first retaining portions 68 can retain the first retained portions 54ba of the left side frame 5L and the right side frame 5R so as to be immovable in the front-rear direction and the second retaining portions 69 can retain the second retained portions 54bb of the left side frame 5L and the right side frame 5R so as to be movable in the front-rear direction.

The second retaining portions 69 can retain the second retained portions 54bb of the left side frame 5L and the right side frame 5R so as to be movable in the front-rear direction, Therefore, when the left side frame 5L and the right side frame SR move as the end plate 3 moves in die front-rear direction, the movement of the second retained portions 54bb of the lower flange portions 54 in the front-rear direction is allowed. That is, displacement of the end plate 3 in the cell stacking direction is allowed, and thus it is possible to alleviate the cell thickness restraint fiction force of the cell stack 2.

The embodiments described above can be appropriately modified, improved, and the like. For example, in the second embodiment, the first retained portion 54ba is retained to the first retaining portion 68 so as to be immovable in the front-rear direction and the second retained portions 54bb are retained to the second retaining portions 69 so as to be movable in the front-rear direction. However, the first retained portion 54ba may be retained to the first retaining portion 68 so as to be movable in the front-rear direction and one of the second retained portions 54bb may be retained to the second retaining portion 69 so as to be immovable in the front-rear direction. In this way, it is possible to consciously bias the displacement amount of the pair of end plates 3 while the displacement of the end plate 3 in the cell stacking direction is allowed. Thus, for example, when bus bar and wire harness are concentrated in one end plate 3, it is possible to suppress the displacement amount of one end plate 3 and to prevent connection failure of bus bar or wire harness.

In the embodiments described above, the plate engaging portion 54c is constituted of a concave portion and the frame engaging portion 65 is constituted of a convex portion. However, the plate engaging portion 54c may be constituted of a convex portion and the frame engaging portion 65 may be constituted of a concave portion.

### SUMMARY

From the embodiments described above, at least the following aspects are extracted. Although the corresponding constituent elements and the like in the embodiments described above are shown in parentheses, it is not limited thereto.

(1) A battery module (battery module 1) including:

a cell stack (cell stack 2) which is constituted by stacking a plurality of cells (cells 21) in a first direction (front-rear direction) and includes a first surface (front surface) which is a surface on one end side in the first direction, a second surface (rear surface) which is a surface on the other end side in the first direction, a third surface (left surface) which is a surface on one end side in a second direction (left-right direction) perpendicular to the first direction, a fourth surface (right surface) which is a surface on the other end side in the second direction, a fifth surface (upper surface) which is a surface on one end side in a third direction (up-down direction) perpendicular to the first direction and the second direction, and a sixth surface (lower surface) which is a surface on the other end side in the third direction;

a pair of end plates (end plates 3) which is disposed on the first surface and the second surface of the cell stack; and

a frame (frame 4) which connects the pair of end plates, in which

the frame includes a pair of connection frames (left side frame 5L and right side frame 5R) disposed on the third surface and the fourth surface of the cell stack, and a base plate (lower plate 6) disposed on the sixth surface of the cell stack,

the pair of end plates each has a protruding portion (protruding portion 33) in a surface facing the base plate, and

the base plate has a groove portion (groove portion 66) which accommodates the protruding portion and extends in the first direction.

According to (1), the movement of the protruding portion of the end plate in the first direction is allowed by the groove portion of the base plate, that is, the displacement of the end plate in the cell stacking direction is allowed, and thus it is possible to alleviate the cell thickness restraint reaction force of the cell stack. On the other hand, since the movement of the protruding portion of the end plate in the second direction is restricted by the groove portion of the base plate, the movement of the end plate in the second direction, that is, the movement of the end plate in the direction perpendicular to the cell stacking direction can be prevented.

(2) The battery module according to (1), in which

the pair of connection frames includes:

first flange portions (lower flange portions 54) extending in a direction approaching each other along a fastening surface of the base plate on a side opposite to a mounting surface on which the cell stack is mounted; and

second flange portions (upper flange portions 53) extending in a direction approaching each other along the fifth surface of the cell stack; and

the first flange portions each has a retained portion (retained portion 54a) which is retained to a retaining portion (retaining portion 67) provided on the fastening surface of the base plate.

According to (2), the cell stack can be pinched between the first flange portion and the second flange portion of the connection frames while the base plate and the connection frames are connected via the retaining portion and the retained portion, and thus the cell group can be aligned.

(3) The battery module according to (2), in which

the retaining portion is provided substantially at a center of the fastening surface of the base plate in the first direction.

According to (3), since the retaining portion is provided substantially at the center of the fastening surface of the base plate in the first direction, the displacement amount of the pair of end plates connected via the connection frames can be averaged.

(4) A battery module (battery module) including:

a cell stack (cell stack 2) which is constituted by stacking a plurality of cells (cells 21) in a first direction (front-rear direction) and includes a first surface (front surface) which is a surface on one end side in the first direction, a second surface (rear surface) which is a surface on the other end side in the first direction, a third surface (left surface) which is a surface on one end side in a second direction (left-right direction) perpendicular to the first direction, a fourth surface (right surface) which is a surface on the other end side in the second direction, a fifth surface (upper surface) which is a surface on one end side in a third direction (up-down direction) perpendicular to the first direction and the second direction, and a sixth surface (lower surface) which is a surface on the other end side in the third direction;

a pair of end plates (end plates 3) which is disposed on the first surface and the second surface of the cell stack; and

a frame (frame 4) which connects the pair of end plates, in which

the frame includes a pair of connection frames (left side frame 5L and right side frame 5R) disposed on the third surface and the fourth surface of the cell stack, and a base plate (lower plate 6) disposed on the sixth surface of the cell stack,

the pair of connection frames includes:

first flange portions (lower flange portions 54) extending in a direction approaching each other along a fastening surface of the base plate on a side opposite to a mounting surface on which the cell stack is mounted; and

second flange portions (upper flange portions 53) extending in a direction approaching each other along the fifth surface of the cell stack,

the first flange portions each includes

a first retained portion (first retained portion 54ba) which is retained to a first retaining portion (first retaining portion 68) provided in the fastening surface of the base plate; and

a second retained portion (second retained portion 54bb) which is retained to a second retaining portion (second retaining portion 69) provided in the fastening surface of the base plate,

the first retained portion is retained to the first retaining portion so as to be immovable in the first direction, and

the second retained portion is retained to the second retaining portion so as to be movable in the first direction.

According to (4), when the connection frames move as the end plate moves in the first direction, the movement of the second retained portion of the first flange portion in the first direction is allowed, that is, the displacement of the end plate in the cell stacking direction is allowed, and thus it is possible to alleviate the cell thickness restraint reaction force of the cell stack.

(5) The battery module according to (4), in which

the first retaining portion is provided substantially at a center of the base plate in the first direction, and

the second retaining portion is provided on an end portion side of the base plate in the first direction.

According to (5), since the first retaining portion is provided substantially at the center of the base plate in the first direction, the displacement amount of the pair of end plates connected via the connection frame can be averaged.

(6) The battery module according to (4), in which

the first retaining portion is provided on an end portion side of the base plate in the first direction, and

the second retaining portion is provided substantially at a center of the base plate in the first direction.

According to (6), since the first retaining portion is provided on the end portion side of the base plate in the first direction, it is possible to consciously bias the displacement amounts of the pair of end plates.

(7) The battery module according to any one of (2) to (6), in which

the second flange portion urges the cell stack toward the first flange portion.

According to (7), since the second flange portion of the connection frame urges the cell stack toward the first flange portion, the cell stack can be elastically pinched between the first flange portion and the second flange portion of the connecting frame to improve the vibration resistance.

(8) The battery module according to any one of (1) to (7), in which

the base plate includes:

a base plate body (lower plate body 61) which extends along the sixth surface of the cell stack: and

a pair of guide portions (guide portions 63) which protrudes from a mounting surface on which the cell stack is mounted along the third surface and the fourth surface of the cell stack in both end portions of the base plate body in the second direction and extend along the first direction.

According to (8), since the base plate includes the base plate body which extends along the sixth surface of the cell stack, and the pair of guide portions which protrude from the mounting surface on which the cell stack is mounted along the third surface and the fourth surface of the cell stack in both end portions of the base plate body in the second direction and extend along the first direction, the movement of the cell in the width direction can be prevented by the guide portion, and thus the vibration resistance can be improved.

(9) The battery module according to any one of (1) to (8), in which

the base plate includes:

a base plate body (lower plate body 61) which extends along the sixth surface of the cell stack; and

a pair of frame engaging portions (frame engaging portion 65) which is provided on a fastening surface of the base plate body on a side opposite to a mounting surface on which the cell stack is mounted and constituted of convex portions or concave portions extending in the first direction, in which

the pair of connection frames includes plate engaging portions (plate engaging portion 54c) which are constituted of concave portions or convex portions extending in the first direction and engaged with the frame engaging portions.

According to (9), since the base plate includes the pair of frame engaging portions constituted of convex portions or concave portions extending in the first direction, and the pair of connection frame each includes plate engaging portions constituted of concave portions or convex portions extending in the first direction and engaging with the frame engaging portions, the movement of the connection frame in the cell width direction with respect to the base plate can be prevented, and thus the vibration resistance can be improved.

1. A battery module comprising:
a cell stack which is constituted by stacking a plurality of cells in a first direction and includes a first surface which is a surface on one end side in the first direction, a second surface which is a surface on the other end side in the first direction, a third surface which is a surface on one end side in a second direction perpendicular to the first direction, a fourth surface which is a surface on the other end side in the second direction, a fifth surface which is a surface on one end side in a third direction perpendicular to the first direction and the second direction, and a sixth surface which is a surface on the other end side in the third direction;
a pair of end plates which is disposed on the first surface and the second surface of the cell stack; and
a frame which connects the pair of end plates, wherein
the frame includes a pair of connection frames disposed on the third surface and the fourth surface of the cell stack, and a base plate disposed on the sixth surface of the cell stack,
the pair of end plates each has a protruding portion in a surface facing the base plate, and
the base plate has a groove portion which accommodates the protruding portion and extends in the first direction.

2. The battery module according to claim 1, wherein
the pair of connection frames includes:
first flange portions extending in a direction approaching each other along a fastening surface of the base plate on a side opposite to a mounting surface on which the cell stack is mounted; and
second flange portions extending in a direction approaching each other along the fifth surface of the cell stack, and
the first flange portions each has a retained portion which is retained to a retaining portion provided on the fastening surface of the base plate.

3. The battery module according to claim 2, wherein
the retaining portion is provided substantially at a center of the fastening surface of the base plate in the first direction.

4. A battery module comprising:
a cell stack which is constituted by stacking a plurality of cells in a first direction and includes a first surface which is a surface on one end side in the first direction, a second surface which is a surface on the other end side in the first direction, a third surface which is a surface on one end side in a second direction perpendicular to the first direction, a fourth surface which is a surface on the other end side in the second direction, a fifth surface which is a surface on one end side in a third direction perpendicular to the first direction and the second direction, and a sixth surface which is a surface on the other end side in the third direction;
a pair of end plates which is disposed on the first surface and the second surface of the cell stack; and
a frame which connects the pair of end plates, wherein
the frame includes a pair of connection frames disposed on the third surface and the fourth surface of the cell stack, and a base plate disposed on the sixth surface of the cell stack,
the pair of connection frames includes:
first flange portions extending in a direction approaching each other along a fastening surface of the base plate on a side opposite to a mounting surface on which the cell stack is mounted; and
second flange portions extending in a direction approaching each other along the fifth surface of the cell stack,
the first flange portions each includes:
a first retained portion which is retained to a first retaining portion provided in the fastening surface of the base plate; and
a second retained portion which is retained to a second retaining portion provided in the fastening surface of the base plate,
the first retained portion is retained to the first retaining portion so as to be immovable in the first direction, and
the second retained portion is retained to the second retaining portion so as to be movable in the first direction.

5. The battery module according to claim 4, wherein
the first retaining portion is provided substantially at a center of the base plate in the first direction, and
the second retaining portion is provided on an end portion side of the base plate in the first direction.

6. The battery module according to claim 4, wherein
the first retaining portion is provided on an end portion side of the base plate in the first direction, and
the second retaining portion is provided substantially at a center of the base plate in the first direction.

7. The battery module according to claim 2, wherein
the second flange portion urges the cell stack toward the first flange portion.

8. The battery module according to claim 1, wherein
the base plate includes:
a base plate body which extends along the sixth surface of the cell stack; and
a pair of guide portions which protrudes from a mounting surface on which the cell stack is mounted along the third surface and the fourth surface of the cell stack in both end portions of the base plate body in the second direction and extend along the first direction.

9. The battery module according to claim 1, wherein
the base plate includes:
a base plate body which extends along the sixth surface of the cell stack; and
a pair of frame engaging portions which is provided on a fastening surface of the base plate body on a side opposite to a mounting surface on which the cell stack is mounted and constituted of convex portions or concave portions extending in the first direction, and
the pair of connection frames includes plate engaging portions which are constituted of concave portions or convex portions extending in the first direction and engaged with the frame engaging portions.
